(19) United States
(12) Patent Application Publication
(10) Pub. No.: US 2011/0015981 A1
(43) Pub. Date: Jan. 20, 2011

(54) SYSTEMS AND METHODS TO INCENTIVIZE TRANSACTIONS TO ENHANCE SOCIAL GOODNESS

(76) Inventor: Mahesh Subramanian, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/556,511

(22) Filed: Sep. 9, 2009

Related U.S. Application Data
(60) Provisional application No. 61/226,651, filed on Jul. 17, 2009.

(51) Int. Cl. G06Q 30/00; G06Q 99/00; G06F 17/00; G06F 3/048

(52) U.S. Cl. 705/14.23; 715/234; 715/810; 705/319; 705/26.1

(57) ABSTRACT

Systems and methods to incentivize transactions to enhance social goodness are described. The system receives a request for a badge representing social goodness of a user of a first network entity. The request includes a user identifier that identifies the user. The system generates the badge based on a social goodness index for the user. The social goodness index may be based on at least one social goodness criteria that is selected from social goodness criterion by the user and transaction information for transactions of items that are transacted by the user on the first network entity. The social goodness index provides a measurement of the social goodness of the user in relation to other users of the first network entity. The system communicates the badge to the second network entity to enable the second network entity to communicate the badge to a third network entity.

### RELATED APPLICATIONS

This application claims the priority benefit of U.S. Provisional Application No. 61/226,651, filed Jul. 17, 2009 which is incorporated herein by reference.

### TECHNICAL FIELD

This disclosure relates to the technical field of data communications. More particularly, systems and methods to incentivize transactions to enhance social goodness.

### RELATED ART

Users may transact goods and services on a network-based marketplace. Some of the transactions may have a greater benefit to the society in which we live.

### BRIEF DESCRIPTION OF THE DRAWINGS

Embodiments illustrated, by way of example and not limitation, in the figures of the accompanying drawings, in which:

FIG. 1 illustrates a system, according to an embodiment, to incentivize transactions to enhance social goodness;

FIG. 2 further illustrates a system, according to an embodiment, to incentivize transactions to enhance social goodness;

FIG. 3 is a block diagram illustrating marketplace applications and payment applications, according to an embodiment;

FIG. 4A is a block diagram illustrating tables, according to an embodiment;

FIG. 4B is a block diagram illustrating a customization table, according to an embodiment;

FIG. 5A is a block diagram illustrating social goodness criterion, according to an embodiment;

FIG. 5B is a block diagram illustrating social goodness groups, according to an embodiment;

FIG. 5C is a block diagram illustrating badge customization information, according to an embodiment;

FIG. 5D is a block diagram illustrating track information, according to an embodiment;

FIG. 6A is a block diagram illustrating a transaction table, according to an embodiment;

FIG. 6B is a block diagram illustrating a transaction, according to an embodiment;

FIG. 6C is a block diagram illustrating an items table, according to an embodiment;

FIG. 6D is a block diagram illustrating a user table, according to an embodiment;

FIG. 7A is a block diagram illustrating transaction incentivizing applications, according to an embodiment;

FIG. 7B is a block diagram illustrating reputation applications, according to an embodiment;

FIG. 7C is a block diagram illustrating navigation applications, according to an embodiment;

FIG. 7D is a block diagram illustrating a request, according to an embodiment;

FIG. 8 is a block diagram illustrating a method, according to an embodiment, to incentivize transactions to enhance social goodness;

FIG. 9A is a flow chart illustrating a method, according to an embodiment, to process transactions;

FIG. 9B is a flow chart illustrating a method, according to an embodiment, to update an index, count, and amount;

FIGS. 10-12B are diagrams user interfaces, according to an embodiment; and

FIG. 13 shows a diagrammatic representation of a machine in the example form of a computer system, according to an example embodiment.

### DETAILED DESCRIPTION

In the following description, for purposes of explanation, numerous specific details are set forth in order to provide a thorough understanding of some example embodiments. It will be evident, however, to one of ordinary skill in the art that embodiments of the present disclosure may be practiced without these specific details.

As described further below, according to various example embodiments of the disclosed subject matter described and claimed herein, systems and methods to incentivize transaction to enhance social goodness are provided. Various embodiments are described below in connection with the figures provided herein.

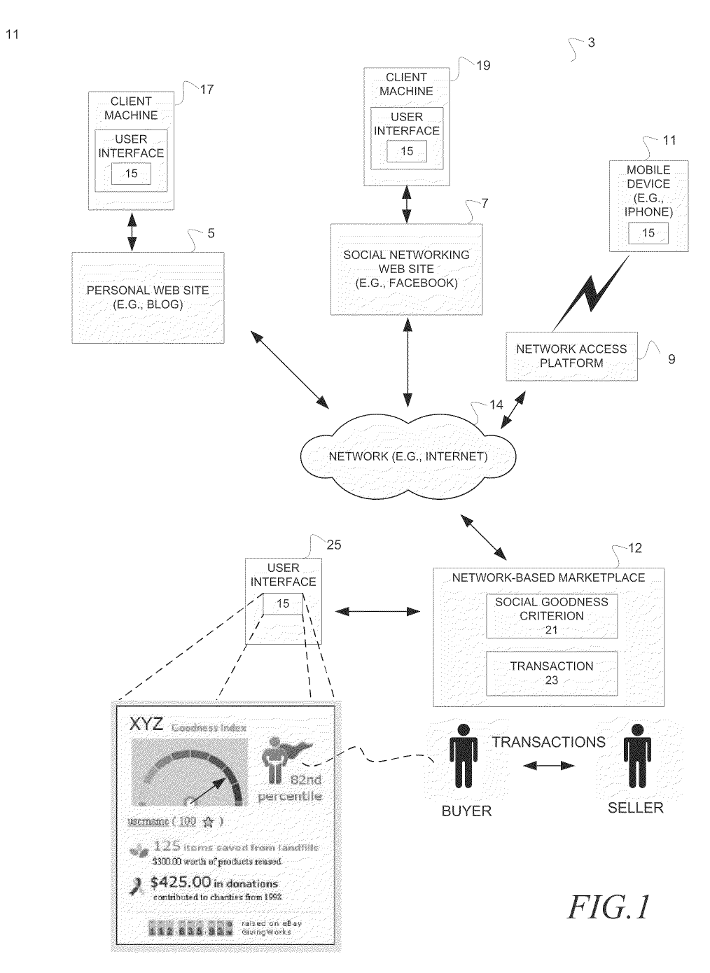

FIG. 1 illustrates a system 3, according to an embodiment, to incentivize transactions to enhance social goodness. The system 3 is shown to include a personal web site 5, a social networking web site, 7 and a network access platform 9 providing connectivity to a mobile device 11, and a network-based marketplace 12. The personal web site 5, the social networking web site, 7 and the mobile device 11, respectively, communicate over a network 14 with the network-based marketplace 12. In one embodiment, the network-based marketplace 12 may communicate a badge 15 that is based on a social goodness index of a user that transacts items on the network-based marketplace 12. For example, the badge 15 may provide a measurement of the social goodness of the user in relation to other users on the network-based marketplace 12. The measurement of the social goodness index may be computed according to one or more social goodness criterion 222 that are selected by the user and applied to transactions 23 executed by the user on the network-based marketplace 12. For example, the user may select social goodness criteria for charitable giving that is applied to transactions in which the user is a buyer or a seller in a sale or auction. Accordingly, the network-based marketplace 12 may apply the charitable giving criteria to transactions to generate the social goodness index for the user. For example, the social goodness index may increase when the user participates in transactions 23 that contribute a percentage of the proceeds towards a charitable cause. Further, the user may configure the personal web site 5, the social networking web site 7, and the mobile device 11 and other web sites and/or devices to display the badge 15. For example, in one embodiment, the personal web site 5 may host a blog that is authored by the user who may configure a user interface to include the badge 15 for display on the client machine 17. Specifically, the user may add a construct in the form of hypertext mark-up language to a user interface that is hosted by the web site 5 to cause the web site 5 to automatically retrieve the badge from the network-based marketplace 12. In another embodiment, the social networking web site 7 may host a user profile that is authored by the user who may configure a user interface to include the badge 15 for display on the client machine 19.

An example badge 15 is illustrated on the user interface 25. The badge 15 includes a “Goodness Index,” a superman image, and an 82^{nd} percentile ranking that respectively represents a social goodness index for a user. The social networking web site 7 may be embodied as FACEBOOK® services, a social utility that connects people with friends and others who work, study and live around them provided by Facebook of Palo Alto, Calif. The mobile device 11 may be embodied as an iPhone mobile phone manufactured by Apple, Inc. of Cupertino, Calif. or, as, a Blackberry™ mobile phone manufactured by Research In Motion of Waterloo, Ontario.

A technical advantage of the above approach may be found in improving operator efficiency. For example, a user may claim in a blog to have attained a social goodness index above a particular level. Nevertheless, in the absence of the above architecture, the proof of such a claim may be authenticated by opening another browser window and reviewing the badge at the network-based marketplace 12. Accordingly, the above described architecture provides operator efficiency in that the social goodness index is automatically generated and distributed in the form of a badge in response to requests from web sites and/or devices that are forwarded to the network-based marketplace 12.

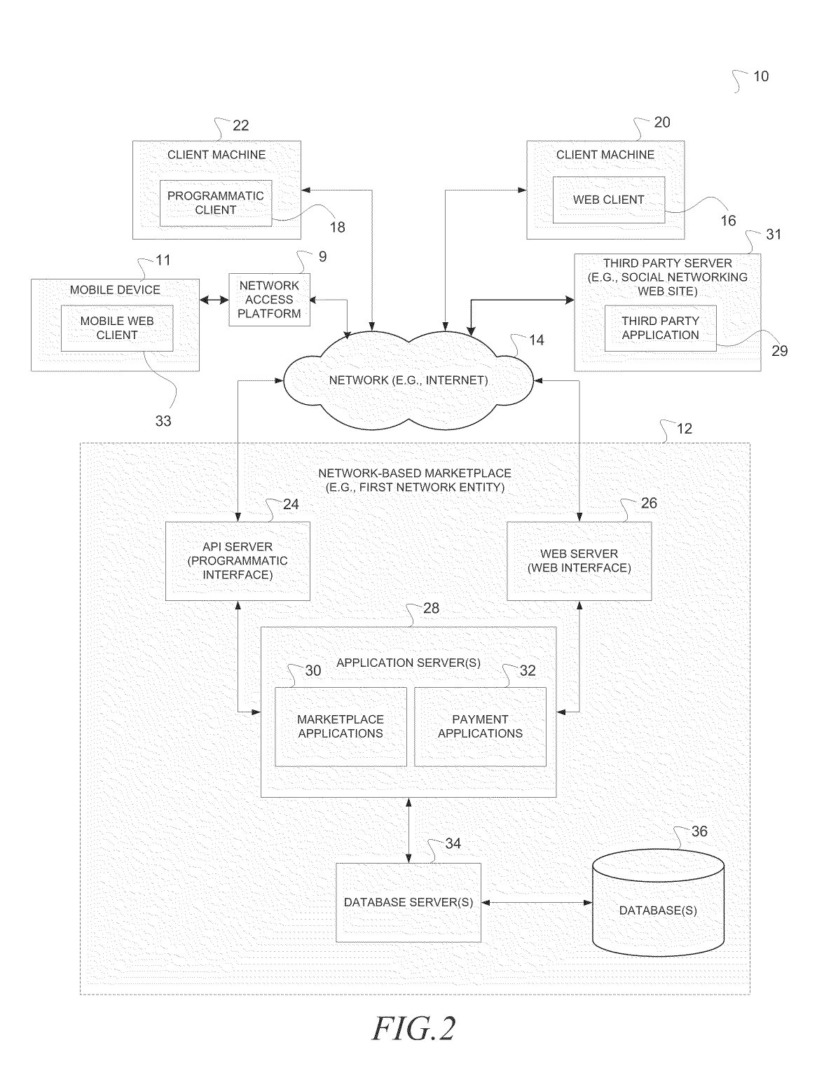

FIG. 2 is a network diagram depicting a networked system 10, within which one example embodiment may be deployed. The networked system 10 corresponds to the system 3 in FIG. 1 and, accordingly, the same or similar references have been used to indicate the same or similar features unless otherwise indicated. A network-based marketplace 12 provides server-side functionality, via a network 14 (e.g., the Internet or Wide Area Network (WAN)) to one or more clients. FIG. 2 illustrates, for example, a web client 16 (e.g., a browser, such as the Internet Explorer browser developed by Microsoft Corporation of Redmond, Wash. State) executing on client machine 20, a programmatic client 18 executing on client machine 22, and a mobile web client 33 executing on mobile device 11. For example, the mobile web client 33 may be embodied as one or more mobile modules that are used to support the Blackberry™ wireless hand held business or smart phone manufactured by Research In Motion of Waterloo, Ontario.

An Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more database servers 34 that facilitate access to one or more databases 36.

The marketplace applications 30 may provide a number of marketplace functions and services to users that access the network-based marketplace 12. The payment applications 32 may likewise provide a number of payment services and functions to users. The payment applications 32 may allow users to accumulate value in accounts and then to later redeem the accumulated value for products (e.g., goods or services) that are made available via the marketplace applications 30. The value may be accumulated in a commercial currency, such as the U.S. dollar, or a proprietary currency, such as “points.” While the marketplace applications 30 and payment applications 32 are shown in FIG. 2 to both form part of the network-based marketplace 12, it will be appreciated that, in alternative embodiments, the payment applications 32 may form part of a payment service that is separate and distinct from the network-based marketplace 12.

Further, while the networked system 10 shown in FIG. 2 employs client-server architecture, embodiments of the present disclosure are of course not limited to such an architecture and could equally well find application in a distributed, or peer-to-peer, architecture system, for example. The various marketplace applications 30 and payment applications 32 could also be implemented as standalone software programs, which do not necessarily have networking capabilities.

The web client 16 and mobile web client 33 access the various marketplace applications 30 and payment applications 32 via the web interface supported by the web server 26. Similarly, the programmatic client 18 accesses the various services and functions provided by the marketplace applications 30 and payment applications 32 via the programmatic interface provided by the API server 24. The programmatic client 18 may, for example, be a seller application (e.g., the TurboLister application developed by eBay Inc., of San Jose, Calif.) to enable sellers to author and manage listings on the network-based marketplace 12 in an off-line manner, and to perform batch-mode communications between the programmatic client 18 and the network-based marketplace 12.

FIG. 2 also illustrates a third party application 29, executing on a third party server machine 31, as having programmatic access to the networked system 10 via the programmatic interface provided by the API server 24. For example, the third party application 29 may retrieve a badge 15 of FIG. 1 that based on the social goodness index from the network-based marketplace 12. The third party website may further, for example, communicate user interfaces to the client machines 22, 20 or mobile device 11 that respectively includes the badge 15.

The mobile device 11 may be embodied as a mobile phone, a personal digital assistant (PDA), a cell phone, or any other wireless device that is capable of communicating with the network-based marketplace 12. For example, the mobile device 11 may be embodied as an iPhone mobile phone manufactured by Apple, Inc. of Cupertino, California or, as previously mentioned, a Blackberry™ mobile phone manufactured by Research In Motion of Waterloo, Ontario.

### Marketplace and Payment Applications

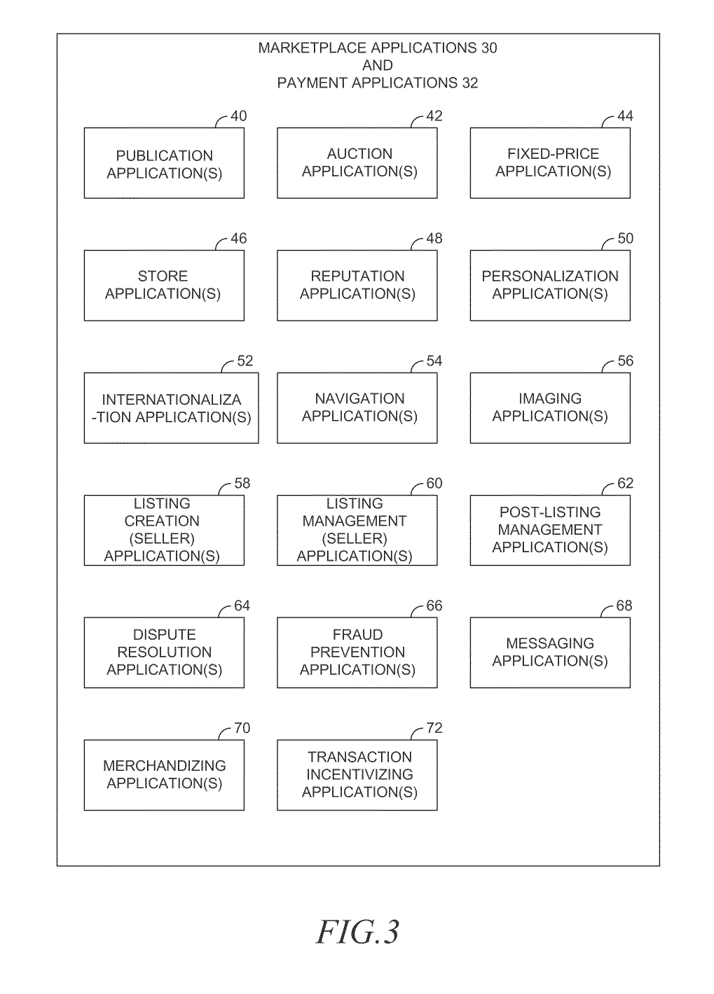

FIG. 3 is a block diagram illustrating marketplace applications 30 and payment applications 32 that, in one example embodiment, are provided as part of the networked system 10 of FIG. 2. The marketplace applications 30 and payment applications 32 may be hosted on dedicated or shared server machines, as shown on FIG. 2, that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 36 via the database servers 34, as shown on FIG. 2.

The network-based marketplace 12 of FIG. 2 may provide a number of publishing, listing and price-setting mechanisms whereby a seller may list (or publish information concerning) goods or services for sale; a buyer can express interest in or indicate a desire to purchase such goods or services; and a price can be set for a transaction pertaining to the goods or services. To this end, the marketplace applications 30 are shown to include at least one publication application 40 and one or more auction applications 42 which support auction-format listing and price setting mechanisms (e.g., English, Dutch, Vickrey, Chinese, Double, Reverse auctions, etc.). The various auction applications 42 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 44 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and may allow a buyer to purchase goods or services, which are also being offered for sale via an auction, for a fixed-price that is typically higher than the starting price of the auction.

Store application(s) 46 allows a seller to group listings within a “virtual” store, which may be branded and otherwise personalized by and for the seller. Such a virtual store may also offer promotions, incentives and features that are specific and personalized to a relevant seller.

Reputation applications 48 allow users that transact, utilizing the network-based marketplace 12, to establish, build and maintain reputations, which may be made available and published to potential trading partners. Consider that where, for example, the network-based marketplace 12 supports person-to-person trading, users may otherwise have no history or other reference information whereby the trustworthiness and credibility of potential trading partners may be assessed. The reputation applications 48 allow a user to establish a reputation within the network-based marketplace 12 over time, for example, through feedback provided by other transaction partners and by the computation of a feedback score based on the feedback. For example, the feedback score may be publicly displayed by the network-based marketplace 12. Other potential trading partners may then reference such a feedback score for the purposes of assessing credibility and trustworthiness.

Personalization applications 50 allow users of the network-based marketplace 12 to personalize various aspects of their interactions with the network-based marketplace 12. For example, a user may, utilizing an appropriate personalization application 50, create a personalized reference page at which information regarding transactions to which the user is (or has been) a party may be viewed. Further, a personalization application 50 may enable a user to personalize listings and other aspects of their interactions with the networked system 10 and other parties.

The networked system 10 may support a number of marketplaces that are customized, for example, for specific geographic regions. A version of the networked system 10 may be customized for the United Kingdom, whereas another version of the networked system 10 may be customized for the United States. Some of these versions may operate as an independent marketplace, or may be customized (or internationalized) presentations of a common underlying marketplace. The networked system 10 may accordingly include a number of internationalization applications 52 that customize information (and/or the presentation of information) by the networked system 10 according to predetermined criteria (e.g., geographic, demographic or marketplace criteria). For example, the internationalization applications 52 may be used to support the customization of information for a number of regional websites that are operated by the networked system 10 and that are accessible via respective servers 24 and 26 both of FIG. 2.

Navigation of the network-based marketplace 12 may be facilitated by one or more navigation applications 54. For example, the network-based marketplace 12 may receive search information to search for items on the network-based marketplace and a processing application may process that request. A browse application may allow users to browse various category, catalogue, or inventory data structures according to which listings may be classified within the networked system 10. Various other navigation applications may be provided to supplement the search and browsing applications.

In order to make listings available via the networked system 10 as visually informing and attractive as possible, the marketplace applications 30 may include one or more imaging applications 56 with which users may upload images for inclusion within listings. An imaging application 56 also operates to incorporate images within viewed listings. The imaging applications 56 may also support one or more promotional features, such as image galleries that are presented to potential buyers. For example, sellers may pay an additional fee to have an image included within a gallery of images for promoted items.

Listing creation applications 58 allow sellers to conveniently author listings pertaining to goods or services that they wish to transact via the network-based marketplace 12, while the listing management applications 60 allow sellers to manage such listings. Specifically, where a particular seller has authored and/or published a large number of listings, the management of such listings may present a challenge. The listing creation applications may further include a processing module, communication module, and listing module that facilitate a buyer watching for specific types of listings. The listing management applications 60 provide a number of features (e.g., auto-relisting, inventory level monitors, etc.) to assist the seller in managing such listings.

One or more post-listing management applications 62 may also assist sellers with a number of activities that may typically occur post-listing. For example, upon completion of an auction facilitated by one or more auction applications 42, a seller may wish to leave feedback regarding a particular buyer. To this end, a post-listing management application 62 may provide an interface to one or more reputation applications 48, so as to allow the seller conveniently to provide feedback regarding multiple buyers to the reputation applications 48.

Dispute resolution applications 64 provide mechanisms whereby disputes arising between transacting parties may be resolved. For example, the dispute resolution applications 64 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 66 implement fraud detection and prevention mechanisms to reduce the occurrence of fraud within the network-based marketplace 12.

Messaging applications 68 are responsible for the generation and delivery of messages to users of the network-based marketplace 12, with such messages, for example, advising users regarding the status of listings at the network-based marketplace 12 (e.g., providing “outbid” notices to bidders during an auction process or to providing promotional and merchandising information to users). Respective messaging applications 68 may utilize any one of a number of message delivery networks and platforms to deliver messages to users. For example, messaging applications 68 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi (e.g., IEEE 802.11 technologies including 802.11n, 802.11b, 802.11g, and 802.11a)), Worldwide Interoperability for Microwave Access (e.g., WiMAX—IEEE 802.16) networks.

Merchandising applications 70 support various merchandising functions that are made available to sellers to enable sellers to increase sales via the network-based marketplace 12. The merchandising applications 70 also operate the various merchandising features that may be invoked by sellers and may monitor and track the success of merchandising strategies employed by sellers. Transaction incentivizing applications 72 may generate badges 15 of FIG. 1 and communicate badges 15 in response to receiving requests. The transaction incentivizing applications may further be accessed by the user to author and customize badges 15. In addition, the user may utilize the transaction incentivizing applications 72 to select one or more criterion that may be used to generate a social goodness index that is used to generate a badge.

### Data Structures

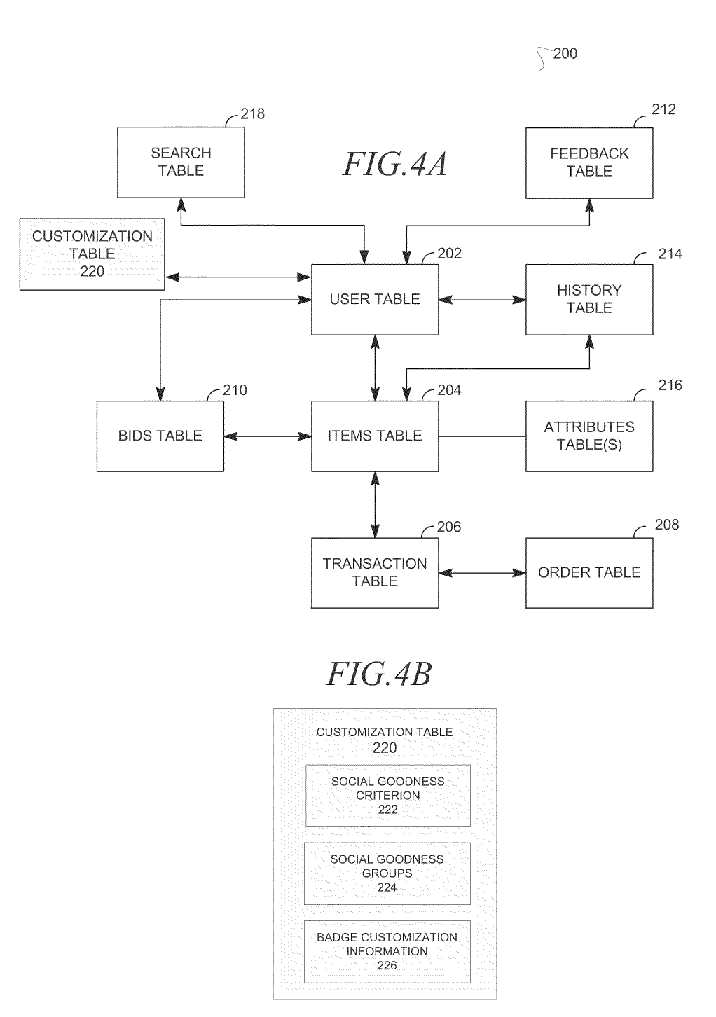

FIG. 4A is a high-level entity-relationship diagram, illustrating various tables 200 that may be maintained within the databases 36 of FIG. 2, and that are utilized by and support the marketplace applications 30 and payment applications 32 both of FIG. 3. A user table 202 contains a record for registered users of the network-based marketplace 12 of FIG. 2. A user may operate as a seller, a buyer, or both, within the network-based marketplace 12. In one example embodiment, a buyer may be a user that has accumulated value (e.g., commercial or proprietary currency), and is accordingly able to exchange the accumulated value for items that are offered for sale by the network-based marketplace 12.

The tables 200 also include an items table 204 in which item records are maintained for goods and services that are available to be, or have been, transacted via the network-based marketplace 12. Item records within the items table 204 may furthermore be linked to one or more user records within the user table 202, so as to associate a seller and one or more actual or potential buyers with an item record.

A transaction table 206 contains a record for each transaction (e.g., a purchase or sale transaction or auction) pertaining to items for which records exist within the items table 204.

An order table 208 is populated with order records, with each order record being associated with an order. Each order, in turn, may be associated with one or more transactions for which records exist within the transaction table 206.

Bid records within a bids table 210 relate to a bid received at the network-based marketplace 12 in connection with an auction-format listing supported by an auction application 42 of FIG. 3. A feedback table 212 is utilized by one or more reputation applications 48 of FIG. 3, in one example embodiment, to construct and maintain reputation information concerning users in the form of a feedback score. A history table 214 maintains a history of transactions to which a user has been a party. One or more attributes tables 216 record attribute information pertaining to items for which records exist within the items table 204. Considering only a single example of such an attribute, the attributes tables 216 may indicate a currency attribute associated with a particular item, with the currency attribute identifying the currency of a price for the relevant item as specified in by a seller.

A search table 218 may store search information that has been entered by a user (e.g., buyer) who is looking for a specific type of listing. A customization table 220 may store customization information for incentivizing transactions that enhance social goodness.

FIG. 4B is a block diagram illustrating a customization table 220, according to an embodiment. The customization table 220 includes social goodness criterion 222, social goodness groups 224, and badge customization information 226. The customization table 220 may be utilized by the user to configure the badge 15, as described further below.

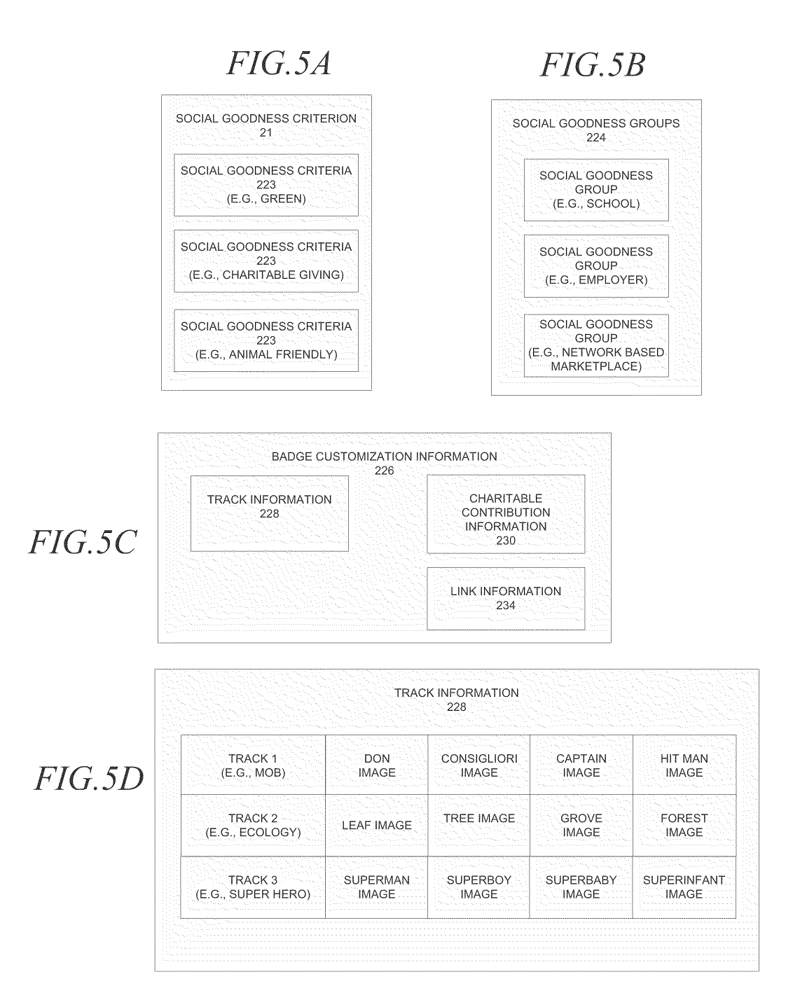

FIG. 5A is a block diagram illustrating social goodness criterion 222, according to an embodiment. The social goodness criterion 222 may include one or more social goodness criteria 223 that may be selected by a user. The social goodness criteria may be in the form of social goodness rules that may be applied to transactions to compute a social goodness index for the user. For example, social goodness criteria 223 may include a “green criteria” that may be used to incentivize transactions that benefit the environment. Also for example, social goodness criteria 223 may include a “charitable giving criteria,” as previously described. Further, for example, social goodness criteria 223 may include an “animal-friendly criteria” that may be used to incentivize transactions that are animal friendly.

FIG. 5B is a block diagram illustrating social goodness groups 224, according to an embodiment. One or more of the social goodness groups 224 may be selected by the user to identify an affiliation with a social goodness group 224 and to designate that a social goodness index for the social goodness group 224 is displayed on the badge of a user. For example, the user may identify an affiliation with a social goodness group 224 in the form of a school that they attended (e.g., Harvard). In response to the selection, the transactions associated with the user and other members of the social goodness group 224 may be pooled together to compute a social goodness index for the group. Merely for example, social goodness groups 224 may include employers, users of the network-based marketplace 12, political parties, churches, social organizations, etc.

FIG. 5C is a block diagram illustrating badge customization information 226, according to an embodiment. The badge customization information 226 may include track information 228, charitable contribution information 230 and link information 234. The badge customization information 226 may support selections received from a user to customize the badge 15 of FIG. 1. The track information 228 may include multiple tracks that respectively support tiered representations of a social goodness index on a badge 15, as described further below. The charitable contribution information 230 may support the addition of a user interface element to a badge 15 that is selectable to enable a charitable contribution to an organization. The link information 234 may support the addition of a user interface element to a badge 15 that is selectable to display an item that is offered for sale or auction on the network-based marketplace 12 of FIG. 2. The link information 234 may support the addition of a user interface element to a badge 15 that is selectable to request a user interface from a network entity. For example, a user interface element may be added to a badge 15 that enables entry to the network-based marketplace 12 to enable configuration of a badge 15 or viewing of an item offered for sale by the user on the network-based marketplace 12.

FIG. 5D is a block diagram illustrating track information 228, according to an embodiment. The track information 228 includes rows and columns. Each row in the track information 228 may support a user selection to customize a badge 15 of FIG. 1. Each row is further associated with a different track that include images that may be used to graphically represent a social goodness index on the badge 15. The columns in a particular track represent segmentations of the track. For example, moving from left to right in a particular track the various segments may include images that are associated with lower social goodness index values. Merely for example, a “track 1” is shown to include a “Mob” track with four different images that may respectively represent ranges within a particular social goodness index where the top twenty-five percentile may be associated with an image of a “Don,” (e.g., Marlon Brando) the next twenty-five percentile may be associated with an image of a “Consigliori,” (e.g., Robert Duvall), and so forth. Accordingly, a user may select “track 1” or “track 2” for representing their social goodness index in their badge 15.

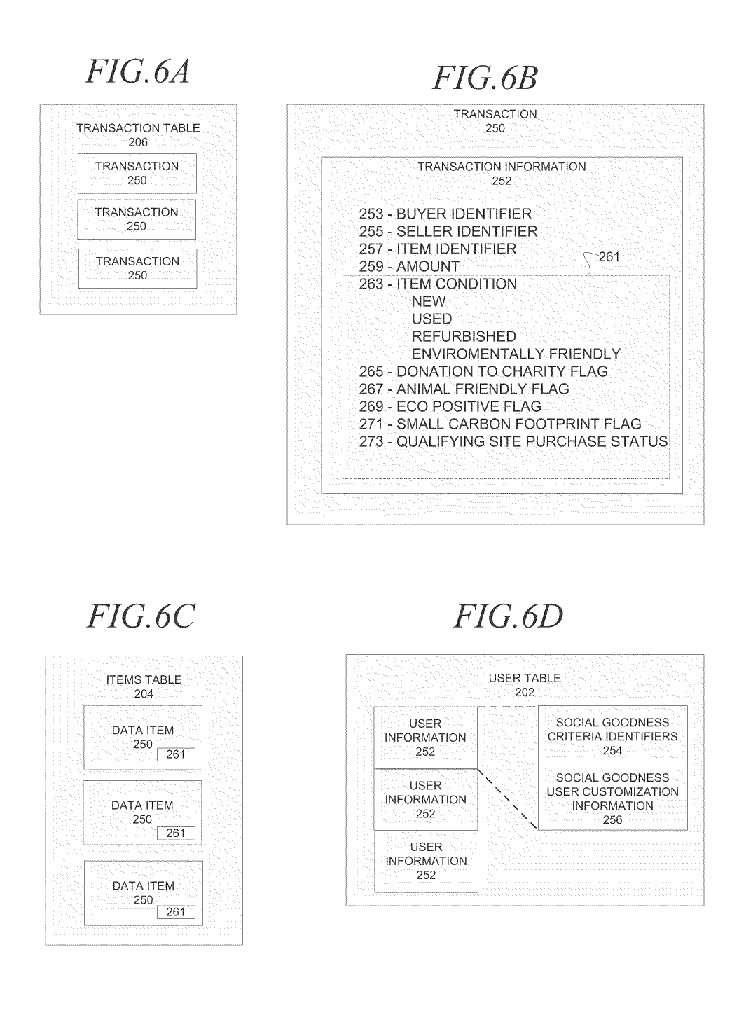

FIG. 6A is a block diagram illustrating a transaction table 206, according to an embodiment. The transaction table 206 may include transactions 250 that have been executed on the network-based marketplace 12 of FIG. 2 or some other network entity. For example, a transaction 250 may record a sale or auction of an item between two users on the network-based marketplace 12.

FIG. 6B is a block diagram illustrating a transaction 250, according to an embodiment. The transaction information 252 may be evaluated with social goodness criterion 222 to compute a social goodness index. The transaction information 252 includes a buyer identifier 253 that identifies a user that is a buyer for the transaction, a seller identifier 255 that identifies a user that is a seller for the transaction, an item identifier 257 that identifies an item transacted, an amount 259, and social goodness tag information 261. The social goodness tag information 261 may be copied into the transaction information 252 based on the item identifier 257. For example, the item identifier 257 may point to a data item for the item transacted in the transaction information 252. The social goodness tag information 261 may be utilized to compute a social goodness index based on the transaction. The social goodness tag information 261 may include an item condition 263, a donation to a charity flag 265, an animal friendly flag 267, an eco positive flag 269, a small carbon footprint flag 271, and a qualifying site purchase status 273. The item condition 263 may include an item condition of “new,” “used,” “refurbished,” or “environmentally friendly.” For example, the item condition 263 of “new” may not enhance a social goodness index unlike the other item conditions “used,” “refurbished,” or “environmentally friendly” that may increase the social goodness index. In one embodiment a transaction of an item associated with an item condition 263 of “used” or “refurbished” may cause an increase in a green/eco friendly index that may be published as such on the badge. In yet another embodiment the green/eco friendly index may be published as a component of the social goodness index. The donation to a charity flag 265 may be asserted to indicate proceeds from the transaction were donated to a charity. The animal friendly flag 267 may be asserted for transactions that are identified as friendly to animals. For example, a transaction 250 for a cosmetic that is produced without performing experiments on animals may be associated with an asserted animal friendly flag 267. The eco positive flag 269 may be asserted for transactions that are identified as positive for the ecosystem. For example, a transaction 250 to purchase energy conserving light bulbs may include an eco positive flag 269 that is asserted. The small carbon footprint flag 271 may be asserted for transactions that are identified as reducing carbon emissions. A carbon footprint is the total set of GHG (greenhouse gas) emissions caused directly and indirectly by an individual, organization, event or product. A transaction for a product that emits a relatively lower amount of CHG emissions may include an asserted small carbon footprint flag 271. The qualifying site purchase status 273 may include a status for transactions on a network entity other than the network-based marketplace that is associated with transactions that may contribute in computing the social goodness index

FIG. 6C is a block diagram illustrating an items table 204, according to an embodiment. The items table 204 may include a data item 250 for each item for sale or auction on the network-based marketplace 12 of FIG. 2. The data item 250 may include item information that is descriptive of the item. The item information may further include social goodness tag information 261, as previously described.

FIG. 6D is a block diagram illustrating a user table 202, according to an embodiment. The user table 202 may include user information 252 for each user that is registered on the network-based marketplace 12 of FIG. 2. The user information 252 may include social goodness criteria identifiers 254 and social goodness user customization information 256. The social goodness criteria identifiers 254 may include one or more social goodness criterion 222 that have been selected by the user. The social goodness user customization information 256 may include one or more social goodness groups 224 of FIG. 5B selected by the user. The social goodness user customization information 256 may further include badge customization information 226 of FIG. 5C selected by the user.

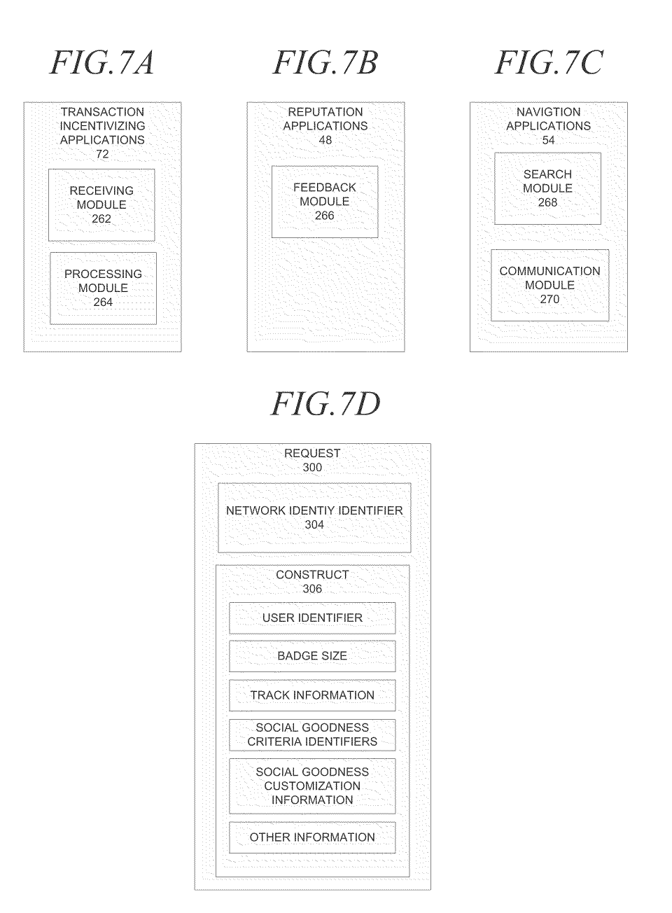

FIG. 7A is a block diagram illustrating transaction incentivizing applications 72, according to an embodiment. The transaction incentivizing applications 72 may include a receiving module 262 and a processing module 264. The receiving module 262 may receive a request for one or more social goodness indexes for a user of the network-based marketplace 12 of FIG. 2 and other information that may appear on a badge 15 of FIG. 1. For example, the request may be received from another module on the network-based marketplace 12 or a network entity other than the network-based marketplace 12 including a personal web site 5 of FIG. 1, a social networking web site 7 of FIG. 1, or a mobile device 11 of FIG. 1. The processing module 264 may process the request. For example, the processing module 264 may generate the social goodness index and the badge 15. Further, the processing module 264 may communicate the badge 15 to the network entity that requested the badge 15.

FIG. 7B is a block diagram illustrating reputation applications 48, according to an embodiment. The reputation applications 48 include a feedback module 266. The feedback module 266 may receive a social goodness index for a user and compute a feedback score for the user based on the social goodness index. Further, the feedback module 266 may communicate the feedback score to the processing module 264 of FIG. 7A.

FIG. 7C is a block diagram illustrating navigation applications 54, according to an embodiment. The navigation applications 54 may include a search module 268 and a communication module 270. The search module 268 may receive a request to search for items on the network-based marketplace 12 of FIG. 2. The request may further include a search filter that includes one or more social goodness criteria 223 of FIG. 5A. For example, the search filter may include social goodness criteria 223 for charitable giving. Accordingly, the navigation applications 54 may identify items with an asserted donation to charity flag 265 of FIG. 6B and respond with search results that includes such items. In addition, the communication module 270 may sort items for display on a user interface according to a social goodness criterion 222. For example, items that are tagged with social goodness tag information 261 of FIG. 6C may appear in search results before items without social goodness tag information 261.

FIG. 7D is a block diagram illustrating a request 300, according to an embodiment, for a badge 15 of FIG. 1. The request 300 may include a network entity identifier 304 and a construct 306. The network entity identifier 304 identifies the network entity that is requesting the badge 15. The construct 306 may include a user identifier that identifies a user associated with the badge, a badge size, track information 228 of FIG. 5C, social goodness criteria identifiers 254 of FIG. 6D, social goodness user customization information 256 of FIG. 6D and other information to generate the badge 15. In one embodiment, the construct 306 may be embodied as a hypertext markup language construct, a shockwave flash construct, a cascading style sheet construct, or a client application. The construct 306 may originate with the user who, prior to a generation of the request 300 by the network entity, copied the construct 306 into a user interface to be generated by the network entity. Henceforth, a generation of the user interface by the network entity may cause a communication of the request 300 that includes the construct 306 to the network-based marketplace 12 of FIG. 2.

### Methods of Operation

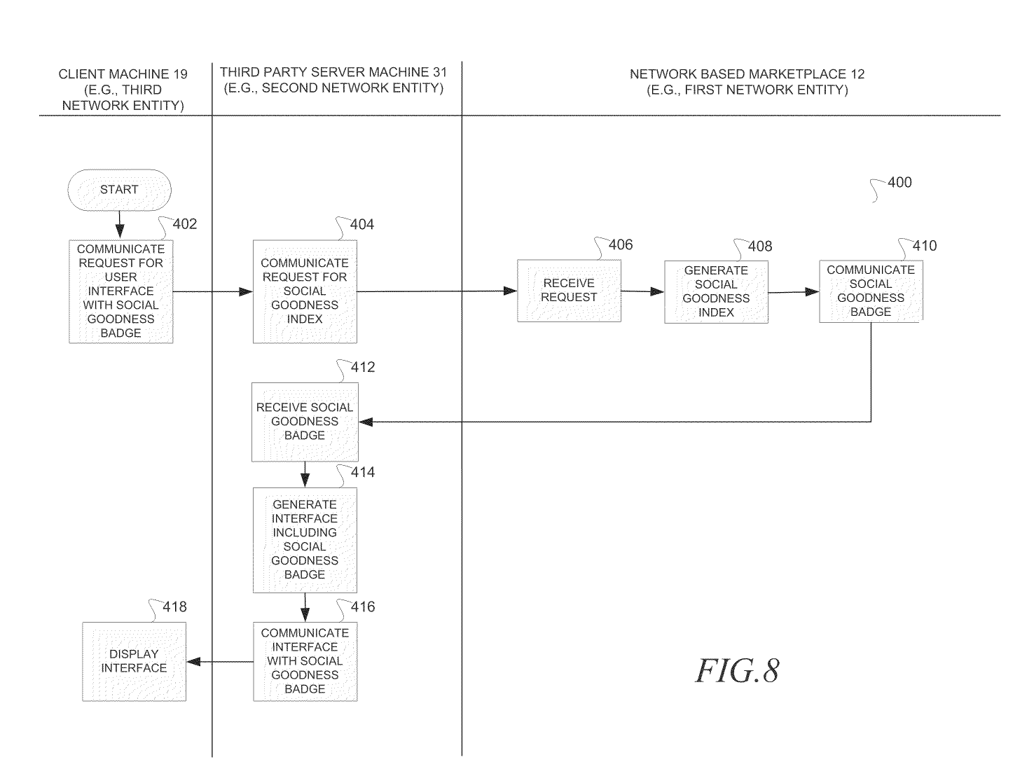

FIG. 8 is a block diagram illustrating a method 400, according to an embodiment, to incentivize transactions to enhance social goodness. Illustrated on the left are operations performed by a third network entity in the form of a mobile device 11 of FIG. 2. Illustrated in the middle are operations performed by second network entity in the form of a third party server machine 31 that in one embodiment may be social network web site. Illustrated on the right are operations performed by a first network entity in the form of a network-based marketplace 12. The method 400 commences at operation 402 with the client machine 19 communicating a request for a user interface that includes a badge 15 of FIG. 1 that displays at least one social goodness index for a user of the network-based marketplace 12.

At operation 404, the third party server machine 31 receives the request for a user interface, identifies a construct 306 of FIG. 7D embedded in the user interface, and communicates a request 300 of FIG. 7D for a badge to the network-based marketplace 12 that includes the construct 306.

At operation 406, the receiving module 262 of FIG. 7A, at the network-based marketplace 12 receives the request 300 and at operation 408 the processing module 264 of FIG. 7A generates a social goodness index for the user. In another example, the processing module 264 may generate additional social goodness indexes for the user responsive to identifying the user is a member of other social goodness groups. At operation 410, the processing module 264 communicates the badge 15 including the social goodness index to the third party server machine 31.

At operation 412, the third party server machine 31 receives the badge 15 and at operation 414 generates a user interface that includes the badge 15. At operation 416, the third party server machine 31 communicates the user interface to the client machine 19.

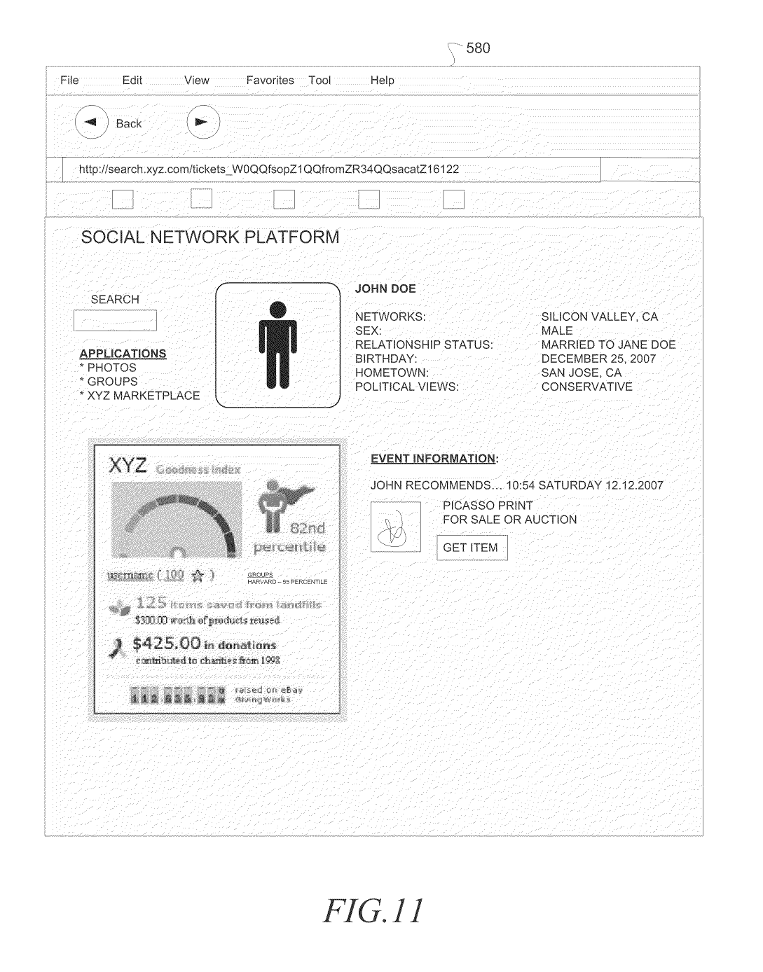

At operation 418, the client machine 19 displays the user interface that includes the badge. For example, FIG. 11 illustrates a user interface that includes the badge 15.

Other embodiments of the method 400 may include generation of the badge 15 at the third party server machine 31 or at the client machine 19. In such instances the network-based marketplace 12 may communicate one or more social goodness indexes for inclusion with the badge 15. In yet another embodiment, the network-based marketplace may further generate a user interface that includes the badge 15 and communicate the user interface to the client machine 19.

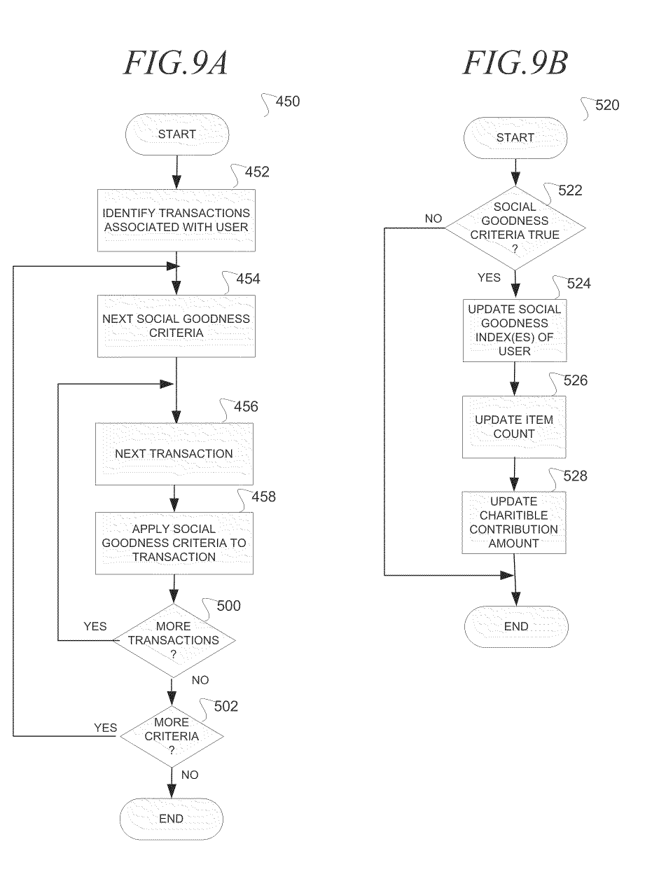

FIG. 9A is a flow chart illustrating a method 450, according to an embodiment, to process transactions. The method 450 may be included in the operation 408 to generate a social goodness index illustrated in the method 400 on FIG. 8. The method 450 commences at operation 452 with the processing module 264 identifying transactions 250 in the transaction table 206 that include a buyer identifier 253 or seller identifier 255 both of FIG. 6B that match the user identifier in the request. At operation 454, the processing module 264 of FIG. 7A identifies the next social goodness criteria 223 of FIG. 5A that is configured by the user to generate a social goodness index for the user. At operation 456, the processing module 264 identifies the next transaction 250 associated with the user. At operation 458, the processing module 264 applies the social goodness criteria 223 to the transaction 250 of FIG. 6A. For example, the processing module 264 may identify whether the transaction 250 includes social goodness tag information 261 of FIG. 6C that is relative to the social goodness criteria 223. At decision operation 500, the processing module 264 identifies if there are more transactions 250 associated with the user. If there are more transactions to be processed, a branch is made to operation 454. Otherwise a branch is made to decision operation 502. At decision operation 502, the processing module 264 may identify if there is another social goodness criteria 223 to process. If there is another social goodness criteria 223 to process a branch is made to operation 454. Otherwise the process ends.

FIG. 9B is a flow chart illustrating a method 520, according to an embodiment, to update an index, count, and amount. The method 520 may be included in the operation 458 in the method 450 as illustrated in FIG. 9A. At decision operation 522, the processing module 264 of FIG. 7A identifies if the social goodness criteria 223 of FIG. 5A is true. For example, the social goodness criteria 223 for charitable giving may be applied to a particular transaction by identifying whether the donation to charity flag 265 of FIG. 6B is asserted. If the social goodness criteria 223 is true then a branch is made to operation 524. Otherwise the process ends. At operation 524, the processing module 264 may update one or more social goodness indexes associated with the user. At operation 526, the processing module 264 may update an item count associated with the user. For example, a transaction 250 of FIG. 6B that describes the sale of an item that results in a charitable contribution may result in incrementing the item count. At operation 528, the processing module 264 may update a charitable contribution amount. For example, a transaction 250 that describes the sale of an item that results in a charitable contribution may result in incrementing the charitable contribution amount.

In yet another embodiment, the 525, 526 and 528 operations may be performed responsive to receipt of a transaction. For example, the processing module 264 may respond to the receipt of a transaction by updating the social goodness indexes, item count, and charitable contribution amount. In this embodiment the social goodness indexes, item count, and charitable contribution amount may subsequently be retrieved in response to a request for a user interface with a social goodness index.

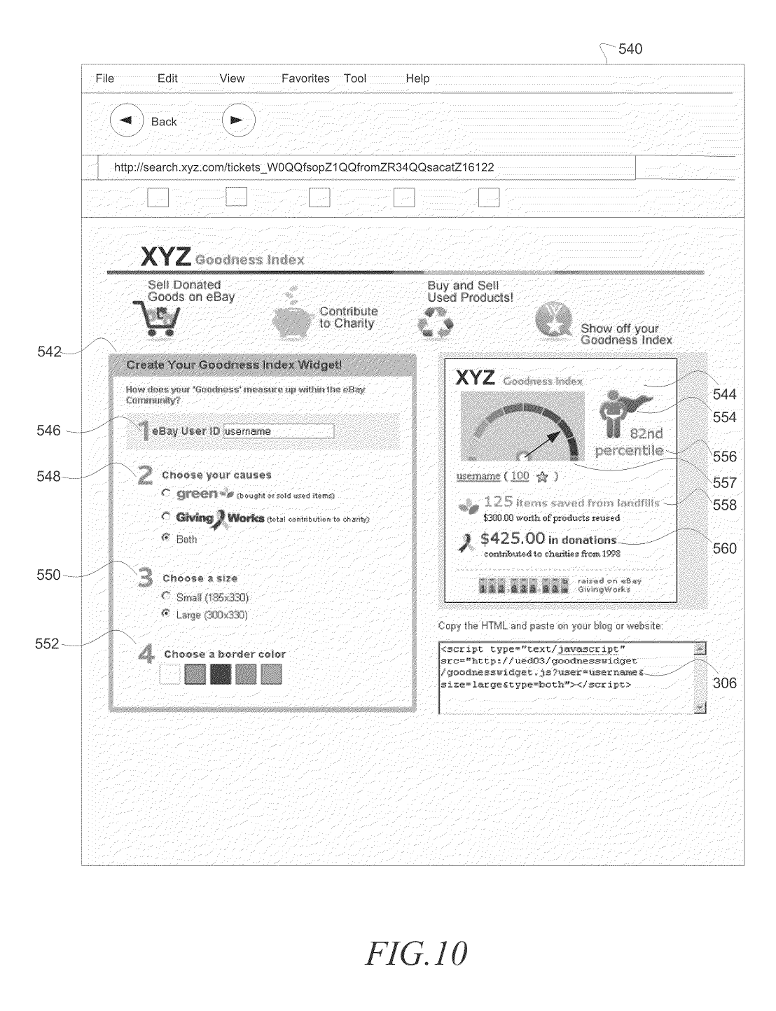

FIG. 10 is a diagram illustrating a user interface 540, according to an embodiment, to configure a badge 15 of FIG. 1. The user interface 540 may be utilized by the network-based marketplace 12 of FIG. 8 to receive badge customization information 226 of FIG. 5C to configure the badge. The user interface 540 includes a configuration panel 542, a badge mock up 544, and a construct 306. The configuration panel 542 includes a receiving box 546 to receive a user name, a radio button group 548 to receive one or more social goodness criteria 223 of FIG. 5A selections, a radio button group 550 to receive a badge size, a user interface element group 552 to receive a border color for the badge 15. Other embodiments of the user interface 540 may be illustrated to receive other badge customization information 226. The badge mock up 544 may display in real time a mock up of the badge 15 based on the badge customization information 226 that is received from the user interface 540. The badge mock up 544 includes an image 554, a percentile 556, a meter 557, an item count 558, and a charitable contribution amount 560. The image 554, percentile 556 and meter 557 may be various representations of the same social goodness index for the user. The image 554 may be track information 228 of FIG. 5C included from a “Super Hero” track that has been tiered as previously described. For example, the illustrated image may correspond to a “Superman Image” in the track. The construct 306 may include hypertext markup language that is generated based on the badge customization information 226 that is received from the user interface 540. The user may copy and paste the construct 306 to a user interface that is displayed by a personal web site 5 of FIG. 1 (e.g., blog) or a social networking web site (e.g., Facebook) or a network-based marketplace 12 (e.g., eBay) where users transact to establish, build, and maintain reputations, which may be made available and published to potential trading partners. Accordingly, a generation of the user interface may cause a request for the badge 15 to be communicated to the network-based marketplace 12.

FIG. 11 is a diagram illustrating a user interface 580, according to an embodiment, to display a badge 15 of FIG. 1. The badge 15 is displayed on a portion of the user interface 580 by a social networking web site that utilized a construct 306 of FIG. 10 embedded in the user interface 580 to retrieve the badge 15 from the network-based marketplace 12 of FIG. 2. For example, the social networking web site may communicate a request 300 of FIG. 7D to retrieve the badge from the network-based marketplace 12.

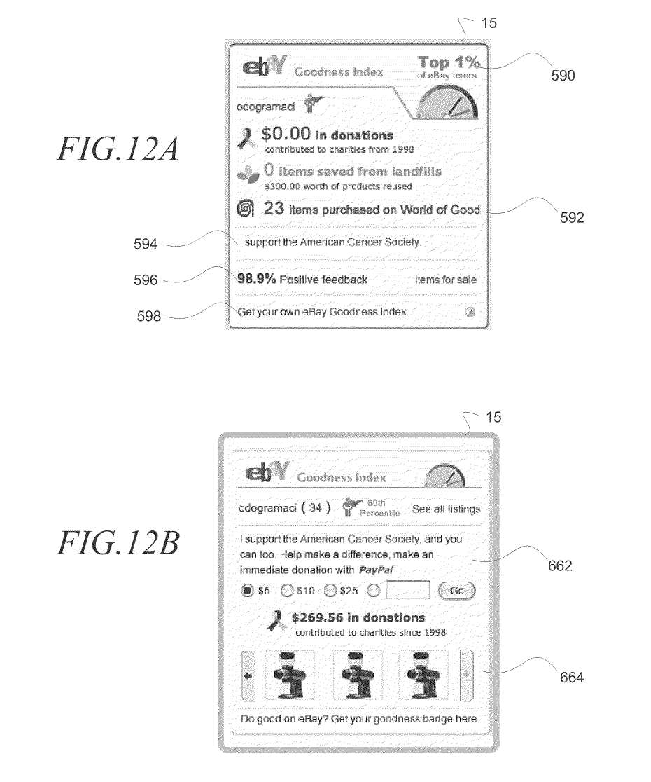

FIG. 12A is a diagram illustrating a badge 15, according to an embodiment. The badge 15 includes user interface elements 590, 592, 594, 596 and 598. The user interface elements 590 may represent the social goodness index of the user. Other embodiments may include additional social goodness indexes. In one embodiment, social goodness indexes may be included to represent transactions associated with a group of users. According to this embodiment users who are members of such a group may publish the social goodness index for the group along with their own social goodness index. For example, a social goodness index for a group may be used to represent a community (e.g., college alumni) or a marketplace (e.g., eBay). Accordingly, individual users who are members of the groups may contribute towards enhancing indexes for their respective groups. Such embodiments may be utilized to foster competition between groups. Merely for example, community groups representing universities such as Berkeley and Standard may compete during September to determine which group may achieve the highest social goodness index. The user interface element 596 is an item count of items purchased from a network entity identified as “World of Good.” The user interface element 594 is a text string that articulates support for a charitable cause. The user interface element 596 is a feedback score, as previously described, that is based on a social goodness index. The user interface element 598 is selectable to request a user interface from the network-based marketplace to configure a badge 15.

FIG. 12B is a diagram illustrating a badge 15, according to an embodiment. The badge 15 includes a receiving box 662 and an item panel 664. The receiving box 662 may receive a donation for a charitable cause from the user that is displaying the user interface that includes the badge 15. The item panel 664 features items that are for sale by the use associated with the badge 15 (e.g., “odogramaci”).

The FIGS. 10-12B included user interfaces or a badge 15 of FIG. 12 A & 12B that utilized various types of user interface elements. However, it will be appreciated by those skilled in the art that the user interfaces or the badge 15 may also be embodied as a machine interface (e.g., Standard Generalized Markup Language—SGML) including machine interface elements, an audio interface including audio interface elements, a kinetic interface including kinetic interface elements, or some other type of interface.

In some embodiments, the methods described herein may be implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level and communicates the results of these logical/mathematical manipulations to the interface tier and/or to a backend, or storage, tier. These logical/mathematical manipulations may relate to certain business rules or processes that govern the software application as a whole. A third, storage tier may be a persistent storage medium or non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer-to-peer, or so some other suitable configuration. Further, these three tiers may be distributed between multiple computer systems as various software components.

Some example embodiments may include the above illustrated tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various APIs, and then compiled into one complete server, client, and/or peer software application. Further, these APIs may be able to communicate through various distributed programming protocols as distributed computing components.

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language by using a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transport Control Protocol/Internet Protocol (TCP/IP) protocol stack model for defining the protocols used by a network to transmit data.

Some embodiments may utilize the OSI model or TCP/IP protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), WAN, or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology) or structures.

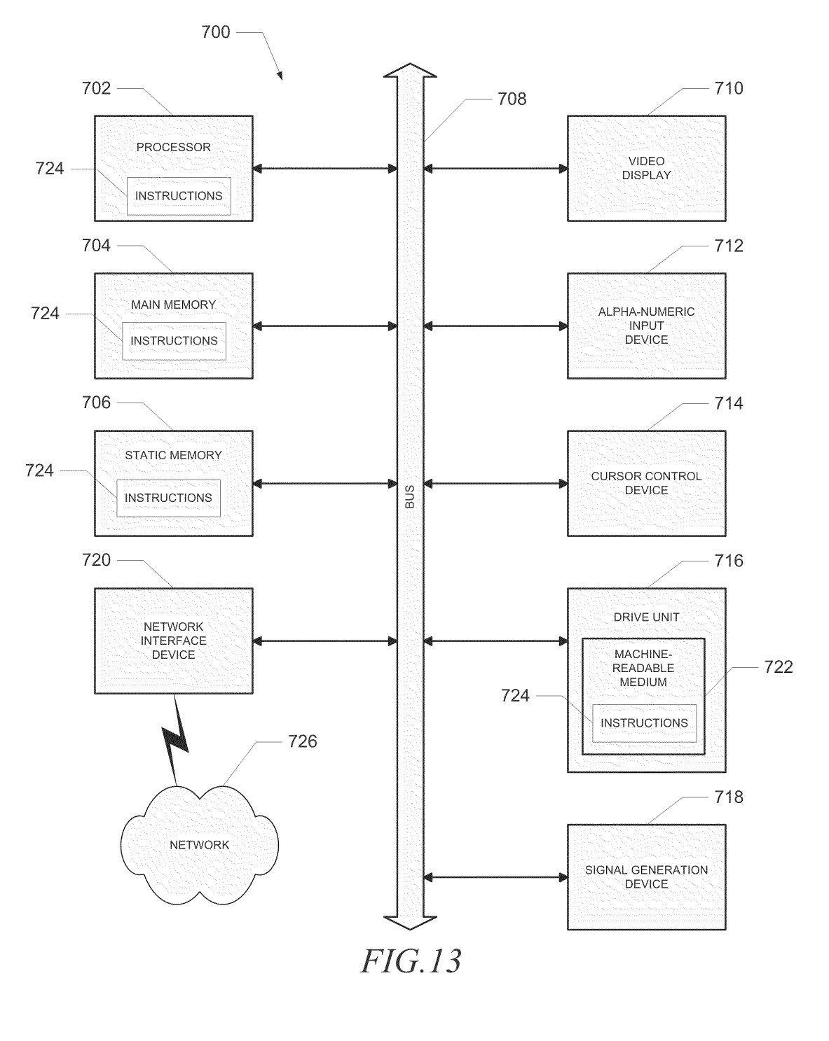

FIG. 13 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g. a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions (e.g., software 724) may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media and magnetic media. As noted, the software may be transmitted over a network using a transmission medium. The term “transmission medium” shall be taken to include any medium that is capable of storing, encoding or carrying instructions for transmission to and execution by the machine, and includes digital or analogue communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, systems and methods to incentivize transactions to enhance social goodness are disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A system to incentivize transactions that enhance social goodness, the system comprising:
a receiving module to receive a request for a badge representing the social goodness of a user of a first network entity, the request communicated from a second network entity to the first network entity, the request includes a user identifier that identifies the user, the first and second network entities respectively included in a plurality of network entities; and
a processing module to generate the badge based on a social goodness index for the user, the social goodness index based on at least one social goodness criteria that is selected by the user from social goodness criterion and transaction information for transactions of items that are transacted by the user on the first network entity, the social goodness index providing a measurement of the social goodness of the user in relation to other users of the first network entity, the processing module to communicate the badge to the second network entity to enable the second network entity to communicate the badge to a third network entity.

2. The system of claim 1, wherein the request includes any one of a group of constructs including a hypertext markup language construct, a shockwave flash construct, a cascading style sheet construct, and a client application, wherein the construct is copied by the user into a user interface that is displayed by the second network entity.

3. The system of claim 1, wherein the first network entity includes a network-based marketplace.

4. The system of claim 3, wherein the processing module identifies whether the transaction information includes a transaction that identifies the user as a seller who has contributed proceeds of the transaction of an item to a charity.

5. The system of claim 3, wherein the processing module identifies whether the transaction information includes a transaction that identifies the user as a buyer of an item that is offered by a seller who has contributed proceeds of the transaction of the item to a charity.

6. The system of claim 3, wherein the processing module identifies whether a transaction identifies a seller as transacting an item in a condition that is selected from a group of conditions including a used condition, a refurbished condition, and an environmentally friendly condition.

7. The system of claim 3, wherein the processing module is to communicate the user interface that includes the badge.

8. The system of claim 1, wherein the badge provides a graphical representation of the social goodness index.

9. The system of claim 8, wherein the graphical representation of the social goodness index is selected from a group of graphical representations including a meter representation, a tiered representation, and a percentile representation.

10. A method to incentivize transactions that enhance social goodness, the method comprising:
receiving a request for a badge representing the social goodness of a user of a first network entity, the request being communicated from a second network entity to the first network entity and including a user identifier that identifies the user, the first and second network entities respectively included in a plurality of network entities;
generating the badge based on a social goodness index for the user, the social goodness index based on at least one social goodness criteria that is selected by the user from social goodness criterion and transaction information for transactions of items that are transacted by the user on the first network entity, the social goodness index providing a measurement of the social goodness of the user in relation to other users of the first network entity; and
communicating the badge to the second network entity to enable the second network entity to communicate the badge to a third network entity.

11. The method of claim 10, wherein the request includes any one of a group of constructs including a hypertext markup language construct, a shockwave flash construct, a cascading style sheet construct, and a client application, wherein a construct is copied by the user into a user interface that is displayed by the second network entity.

12. The method of claim 10, wherein the first network entity includes a network-based marketplace.

13. The method of claim 10, wherein the generating includes identifying whether the transaction information includes a transaction that identifies the user as a seller who has contributed proceeds of the transaction of an item to a charity.

14. The method of claim 10, wherein the generating includes identifying whether the transaction information includes a transaction that identifies the user as a buyer of an item that is offered by a seller who has contributed proceeds of the transaction of the item to a charity.

15. The method of claim 10, wherein the generating the social goodness index includes identifying whether the transaction identifies a buyer as transacting an item in a condition that is selected from a group of conditions including a used condition, a refurbished condition, and an environmentally friendly condition.

16. The method of claim 10, wherein the badge provides a graphical representation of the social goodness index.

17. The method of claim 16, wherein the graphical representation of the social goodness index is selected from a group of graphical representations including a meter representation, a tiered representation, and a percentile representation.

18. The method of claim 10, wherein the badge includes a second social goodness index that is selected from a group of social goodness indexes including a social goodness index for a plurality of users that is based on the social goodness index for the user and a social goodness index for a plurality of users that utilize a network-based marketplace that is based on the social goodness index for the user.

19. The method of claim 10, wherein the badge includes a user interface element that is selected from a group of user interface elements that include a first user interface element that is selectable to make a charitable contribution, a second user interface element that is selectable to display item information for an item, and a third user interface element that is selectable to request a user interface from a different network entity.

20. The method of claim 10, wherein the social goodness index is utilized to compute a feedback score that is utilized by the other users to assess credibility and trustworthiness of the user on a network-based marketplace.

21. The method of claim 10, further including receiving the request to search for items on a network-based marketplace based on a search filter that includes the social goodness criteria.

22. The method of claim 10, wherein the second network entity includes any one of a group of network entities including a mobile device, a social networking web site, and a personal web site.

23. The method of claim 10, further including communicating a user interface that includes items for sale that are positioned on the user interface based on the social goodness criteria.

24. A system to incentivize transactions that enhance social goodness, the system comprising:
a receiving module to receive a request for a badge representing the social goodness of a user of a first network entity, the request communicated from a second network entity to the first network entity, the request includes a user identifier that identifies the user, the first and second network entities respectively included in a plurality of network entities; and
a means for generating the badge based on a social goodness index for the user, the social goodness index based on at least one social goodness criteria that is selected by the user from social goodness criterion and transaction information for transactions of items that are transacted by the user on the first network entity, the social goodness index providing a measurement of the social goodness of the user in relation to other users of the first network entity, the first means for communicating the badge to the second network entity to enable the second network entity to communicate the badge to a third network entity.

25. A machine-readable medium storing instructions that, when executed by at least one processor, cause the at least one processor to perform the following actions:
receiving a request for a badge representing social goodness of a user of a first network entity, the request being communicated from a second network entity to the first network entity and including a user identifier that identifies the user, the first and second network entities respectively included in a plurality of network entities;
generating the badge based on a social goodness index for the user, the social goodness index based on at least one social goodness criteria that is selected by the user from social goodness criterion by the user and transaction information for transactions of items that are transacted by the user on the first network entity, the social goodness index providing a measurement of the social goodness of the user in relation to other users of the first network entity; and
communicating the badge to the second network entity to enable the second network entity to communicate the badge to a third network entity.
